(19) United States
(12) Patent Application Publication
(10) Pub. No.: US 2021/0065094 A1
(43) Pub. Date: Mar. 4, 2021

(54) ASSESSING JOB METADATA QUALITY AND AUTOMATICALLY SUGGESTING CORRECTIVE ACTIONS

(71) Applicant: Microsoft Technology Licensing, LLC, Redmond, WA (US)

(72) Inventors: Christian V. Mathiesen, San Jose, CA (US); Emrecan Dogan, Menlo Park, CA (US); Mustafa Emre Kazdagli, Palo Alto, CA (US); Alp Artar, San Francisco, CA (US)

(21) Appl. No.: 16/556,682

(22) Filed: Aug. 30, 2019

(51) Int. Cl. G06Q 10/06

(52) U.S. Cl. CPC G06Q 10/063112; G06Q 10/06398

(57) ABSTRACT

Technologies for suggesting changes to job posting data to increase performance of a job posting for a job opportunity are provided. The disclosed techniques include a system receiving poster data that includes a plurality of attributes for the job posting. The job posting is creating based on the poster data. Once created, the job posting is made available through a content management system to job seekers. While the job posting is available through the content management system, a first performance metric is determined for the job posting. A plurality of similar job postings is identified. A second performance metric is determined based upon the plurality of similar job postings. A comparison is performed between the first and second performance metric. Based on the comparison, a suggested change to the job posting is determined and the system causes the suggested change to be presented to the poster of the job posting.

### TECHNICAL FIELD

The present disclosure relates to assessing data associated with a job posting and, more particularly to, determining whether to suggest corrective actions for the job posting based upon interaction data associated with the job posting.

### BACKGROUND

The Internet has facilitated the rapid development of modern technologies, including instant communication and coordination regardless of geography. Modern technology has transformed many industries, including talent acquisition. Hirers have access to a virtually limitless pool of geographically dispersed candidates while candidates can be matched to organizations with very little effort.

A drawback hirers may have in finding candidates for opportunities is ensuring that their job posting is visible to suitable candidates. For example, if a hirer is looking for a database engineer, then the hirer would like their job posting to target job seekers that are database engineers. However, if the job posting contains inaccurate or incomplete information, then the job posting may not be presented to job seekers who match the desired qualifications of the job posting.

One solution to this problem is to enable quality control measures that evaluate the information provided by the job poster during job posting creation, in order to ensure that the qualifications for the job are accurate and complete. For example, quality control measures may check for a conforming job title, list of skills desired, and a complete description of the job opportunity. However, quality control measures may be cumbersome to job posters as they may be forced to conform to standard job posting practices set forth by the quality control measures. This may also cause issues if the job opportunity is a new type of position that does not fit the standard template of the standard job posting practices. As a result, job posters may be reluctant to use the job posting system and may seek to post their job opportunity elsewhere.

Another solution to this problem is to present the job poster with tips on what should be included in the job posting. However, the tips may be based on the standard job posting practices set forth by the quality control measures. The tips may not reflect actual deficiencies with the job posting that may be causing poor engagement by job seekers. For example, a job poster may post a new engineering job, which has a non-standard job title, for a well-known and popular company. The job posting may perform poorly based on a set of strict qualification requirements; however conventional solutions may propose tips that include changing the job title to a standard job title. This suggestion, however, is not based on the reason for the poor job posting performance. In fact, if the job poster accepts the tip and switches the non-standard job title with the standard job title, the change in job title may actually adversely affect job posting performance. As a result, conventional systems may provide standard job posting tips which may not be helpful and which may be harmful to improving engagement with a job posting.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for evaluating performance of a job posting and determining one or more suggestions to improve performance of the job posting, in an embodiment.

FIG. 2 depicts a table of sample suggested changes to be made to a job posting for the purpose of increasing relative performance of the job post, in an embodiment.

FIG. 3 depicts an example flowchart for selecting a suggested change to data in a job posting and presenting the suggested change to a job poster device, in an embodiment.

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, some structures and devices are shown in block diagram form in order to avoid unnecessarily obscuring the present invention.

### General Overview

As disclosed herein, suggesting relevant changes to job posting data is improved by adding technology that implements a particular approach of determining performance metric data for a job posting and only suggesting changes to job posting data, if the performance metric data indicates that the performance of the job posting is below a certain threshold, in order to increase response performance of the job posting for a job opportunity. In one technique, poster data, that includes a plurality of attributes for a job posting, is received by the system. The plurality of attributes may include, for example, a job title, a job location, job skills, seniority level required or preferred for the job posting, and a job posting description. A job posting is created based on the poster data. Once created, the job posting is made available through a content management system. The content management system may represent a content platform implemented to display content to users within a user session. While the job posting is available through the content management system, a first performance metric is determined for the job posting. The first performance metric may be based upon user interactions, within the content management system, by users over a specified period of time.

In an embodiment, a plurality of job postings is identified, where job postings in the plurality of job postings are similar to the job posting that has been made available. For example, the plurality of job postings may have similarities to the job postings based upon job title, job location, job skills, job seniority, or any other similar attributes between the job posting and the identified plurality of job postings. Upon identifying the plurality of job postings, a second performance metric is determined based upon the plurality of job postings. A comparison between the first performance metric and the second performance metric is performed. This comparison enables the system to evaluate performance of the job posting relative to similar job postings represented by the plurality of job postings. Based upon the comparison, a suggested change to the job posting is determined and the system causes the suggested change to the job posting to be presented to the poster of the job posting.

Embodiments improve computer technology related to electronic job postings by dynamically suggesting changes to content within a job posting in order to improve response rate of the job posting. Instead of burdening a job poster with excessive posting templates and rules, the system allows a poster to create and post a job post, as intended. The system then tracks interactions with the job posting and determines whether the job posting is performing well or poorly, with respect to similar job postings. If the job posting is performing poorly, then the system determines a suggested change to improve relative performance of the job posting. The suggested change is a dynamic suggestion that is based on the collected interaction data and job attribute differences derived from the job posting and identified similar job postings. By providing a suggested change that takes into account current job posting performance, relative to similar job postings, and differences in job posting attributes between the current job posting and the similar job postings, the suggested change is more likely to result in improved response performance for the job posting.

The disclosed approaches provide advantages over conventional solutions by improving the quality of suggested changes presented for a job posting. This improves the likelihood of better response performance for the job post, without the need for the job poster to repeatedly change job attributes within the job posting. These improvements will reduce the amount of computing resources devoted to editing and re-editing job posting content, which is associated with a trial and error approach to improving performance of the job posting.

### Definitions

A job poster is an individual, an organization, or a group of individuals responsible for posting information about a job opportunity. A job poster may be different than the entity that provides the job (i.e., the “job provider”). For example, the job poster may be an individual that is employed by the job provider. As another example, the job poster may be a recruiter that is hired by the job provider to create one or more job posting. A job provider may be an individual, an organization (e.g., company or association), or a group of individuals that require, or at least desire, a job to be performed.

A “job” is a task or piece of work. A job may be voluntary in the sense that the job performer (the person who agreed to perform the job) has no expectation of receiving anything in exchange, such as compensation, a reward, or anything else of value to the job performer or another. Alternatively, something may be given to the job performer in exchange for the job performer's performance of the job, such as money, a positive review, an endorsement, goods, a service, or anything else of value to the job performer. In some arrangements, in addition to or instead of the job provider, a third-party provides something of value to the job performer, such as academic credit to an academic institution.

A “job opportunity” is associated with a job provider. If a candidate for a job opportunity is hired, then the particular entity becomes the employer of the candidate. A job opportunity may pertain to full-time employment (e.g., hourly or salaried), part-time employment (e.g., 20 hours per week), contract work, or a specific set of one or more tasks to complete, after which employment may automatically cease with no promise of additional tasks to perform.

A “job seeker” is a person searching for one or more jobs, whether full-time, part-time, or some other type of arrangement, such as temporary contract work. A job seeker becomes an applicant for a job opportunity when the job seeker applies to the job opportunity. Applying to a job opportunity may occur in one of multiple ways, such as submitting a resume online (e.g., selecting an “Apply” button on a company page that lists a job opportunity, selecting an “Apply” button in an online advertisement displayed on a web page presented to the job seeker, or sending a resume to a particular email address) or via the mail, or confirming with a recruiter that the job seeker wants to apply for the opportunity.

A “job posting” is an object that represents a specific job opportunity, provided by a job provider. The job posting is presented within content management system to job seekers. For example, a job poster may create a job posting that represents a job opportunity and may activate the job posting so that the job posting is available to job seekers within the content management system. The job posting may include one or more job attributes that describe the job opportunity, the preferred and required skills for the job opportunity, and any other relevant information that describes the job opportunity. For example, the job attributes may include the job title, the job location, the desired seniority level of applicants, skills preferred or required for the job opportunity, benefits associated with the job opportunity, and screening questions for sorting and filtering potential applicants.

A “job application” is a set of data about a job applicant submitted for a job opportunity. A job application may include a resume of the applicant, contact information of the applicant, a picture of the applicant, an essay provided by the applicant, answers to any screening questions, an indication of whether any one of one or more assessment invitations have been sent to the applicant, an indication of whether the applicant completed any of the one or more assessments, and results of any assessments that the applicant completed. A resume or other parts of a job application may list skills, endorsements, and/or qualifications that are associated with the applicant and that may be relevant to the job opportunity.

A “reviewer” is an individual, an organization, or a group of individuals responsible for reviewing applications for one or more job opportunities. A reviewer may be the same entity as the job poster. For example, a reviewer and the corresponding job poster may refer to the same company. Alternatively, a reviewer and the corresponding job poster may be different individuals associated with (or otherwise affiliated with) the same company. In that situation, one person is responsible for posting a job and another person is responsible for reviewing applications. Alternatively, a reviewer may be affiliated with a different party than the job poster. In fact, the job provider, the job poster, and the reviewer may be different parties/companies.

### System Overview

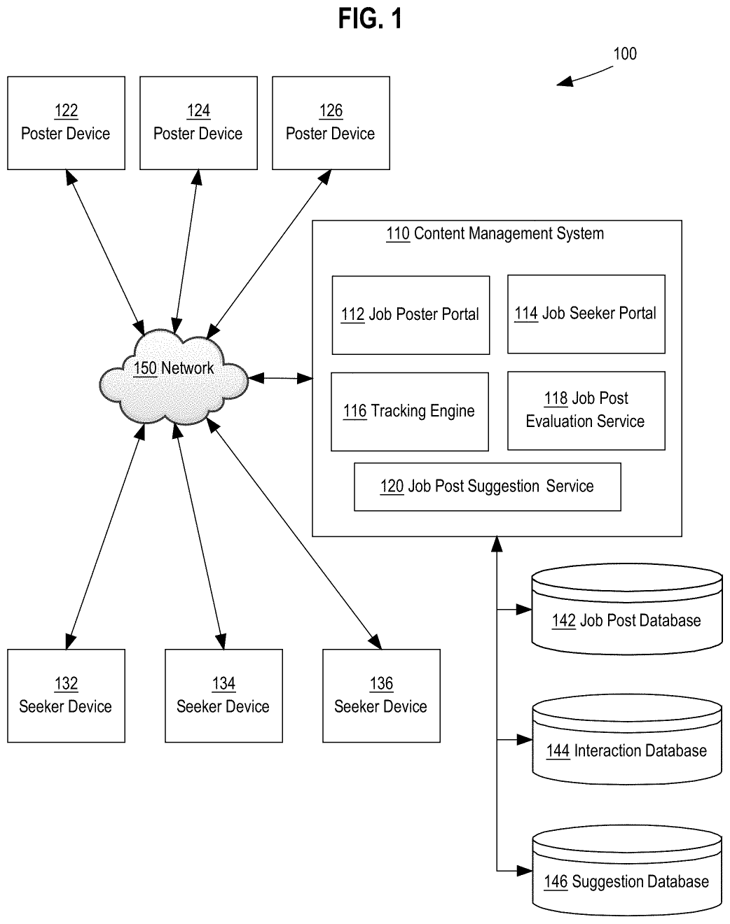

FIG. 1 is a block diagram that depicts an example system 100 for evaluating performance of a job posting and determining one or more suggestions to improve performance of the job posting. System 100 includes poster devices 122-126, a content management system 110, seeker devices 132-136, a job post database 142, an interaction database 144, a suggestion database 146, and a network 150. In an embodiment, poster devices 122-126 are operated by end-users, such as job posters and reviewers, and send data and/or requests to content management system 110 over network 150. Similarly, seeker devices 132-126 are operated by end-users, such as job seekers, and send data and/or requests to the content management system 110 over network 150 or another computer network. In an embodiment, the content management system 110 manages user sessions and provides users content within websites, user feeds, notifications, and any other medium for consuming content. The content management system 110 allows job posters to create job postings, activate created job postings so that job seekers may view and apply for such job postings, edit created job postings, and review applicant data for active job postings. The content management system 110 allows job seeking users to search, view, and consume content related to job postings within their respective user sessions. Although depicted in a single element, the content management system 110 may comprise multiple computing elements and devices (e.g., file servers and database systems), connected in a local network or distributed regionally or globally across many networks, such as the Internet. Content management system 110 may include an interface that allows job posters to create and manage their respective job postings and another interface that allows job seekers to view and interact with active job postings.

In an embodiment, the content management system 110 may include a job poster portal 112, a job seeker portal 114, a tracking engine 116, a job post evaluation service 118, and a job post suggestion service 120.

### Job Poster Portal

The job poster portal 112 provides a graphical user interface to job posters for generating and editing job postings. In an embodiment, poster devices 122-126 interact with the content management system 110 over network 150 through the job poster portal 112. For example, the job poster portal 112 receives login credentials from job poster device 122, identifies an account associated with the login credentials, and presents data related to one or more job postings that are associated with the account. A job poster device submits requests to the content management system 110 via the job poster portal 112. Requests may be generated and submitted in response to user input to a user interface displayed on the poster device, such as selection of a graphical button. The poster device executes a client application, which may be a native application or a web application that executes within a web browser, such as Internet Explorer, Mozilla Firefox, and Google Chrome.

The client application displays the graphical user interface and includes selectable options for creating new job postings, navigating existing job postings associated with a job poster account, and viewing job applications for job postings submitted by job seekers. The graphical user interface may display forms and selectable options for creating a new job posting. For example, the graphical user interface may display a series of text boxes, radio buttons, and drop-down menus for providing job posting data including, but not limited to, job title, job location, job description, required and/or preferred skills, required and/or preferred qualifications, required and/or preferred experience, and any other relevant information related to a job opportunity. The graphical user interface may include one or more additional pages for inputting job screening criteria. Job screening criteria represents one or more job screening questions that may be presented to a potential job seekers in order to determine whether the job seeker is appropriate for the job opportunity represented by the job posting. For example, a job poster may enter job screening criteria that includes questions such as, “do you have a computer science degree?”, “are you eligible to work in the United States?”, and “do you have 5 or more years of software engineering experience?”. The purpose of the job screening criteria is to select a subset of interested job seekers that meet the qualifications for the job posting. Questions within the job screening criteria may be made as either required or preferred. A required question may be a question that the job seeker must pass in order to be considered for the job opportunity. For example, if the question “are you eligible to work in the United States?” is marked as required, then that means only job seekers that are eligible to work in the United States are going to be considered for the job opportunity. A preferred question is a question that does not necessarily eliminate job seekers from being considered for the job opportunity. For instance, if the question “do you have 5 or more years of software engineering experience?” is marked as preferred, then job seekers that have less than 5 years of software engineering experience may still be considered for the job opportunity but may not be a preferred candidate.

In an embodiment, the job poster portal 112 may store job posting data for job postings in the job post database 142. The job post database 142 may represent a data repository implemented to store and manage relevant data related to job postings. Relevant data may represent job poster information, such as job posting accounts, posted jobs, associated qualifications for the posted jobs, and job application information, such as a job seeker's user profile, answers to screening questions, the job seeker's resume, and any other data associated with job seekers.

### Job Seeker Portal

The job seeker portal 114 provides graphical user interfaces to job seekers to search for and view job opportunities presented as job postings. In an embodiment, seeker devices 132-136 interact with the content management system 110 over network 150 through the job seeker portal 114. For instance, the content management system 110 receives login credentials from job seeker device 132, identifies an account associated with the login credentials, and presents content associated with the account identified. Content may be presented within graphical user interfaces such as a job seeker home page for searching for job opportunities, a user content feed that includes job postings along with other content, or any other graphical user interface customized for displaying job postings associated with the account identified.

In an embodiment, within a user session, the content management system 110 may receive a request that selects the one or more buttons or links to the job seeker portal 114. In response to receiving the request, the content management system 110 may forward the request to the job seeker portal 114. The job seeker portal 114 may display one or more job postings that are relevant to the job seeker. For example, if the job seeker is a software engineer, then the job seeker portal 114 may initially display job postings that are looking for software engineers. The graphical user interface for displaying the job postings may be implemented by a client application, which may be a native application or a web application that executes within a web browser, such as Internet Explorer, Mozilla Firefox, and Google Chrome.

In another embodiment, the job seeker portal 114 may integrate graphical elements for displaying job postings within a content feed. For example, the job seeker device 132 may implement a client application that displays content within a content feed. The job seeker portal 114 may send job postings to the content feed for display. If a job posting is selected from the content feed, then the job seeker portal 114 may display, within the graphical user interface of the client application, the selected job posting within one or more action buttons that allow the user to apply for the job opportunity and/or request additional information about the job opportunity.

In an embodiment, the job seeker portal 114 may access stored job posting data for job postings from the job post database 142 for the purpose of displaying the job postings to job seekers. The job seeker portal 114 may associate job seeker information with job postings when a job seeker applies for a particular job opportunity and/or requests additional information related to a job opportunity. For example, if a job seeker using the job seeker device 132 clicks an apply button, within the graphical user interface of the client application, for a particular job post, the job seeker portal 114 may generate a job application that includes a link to the user profile of the job seeker, the job seeker's resume, and any other information relevant to the particular job post.

### Tracking Engine

The tracking engine 116 tracks user interactions by job seekers and by job posters with respect to corresponding job postings. By tracking how users interact with job postings, the tracking engine 116 may generate performance metrics for evaluating whether a particular job posting is performing well or performing poorly. In an embodiment, the tracking engine 116 may track job poster interactions by recording the number messages sent from the job poster to job seekers that showed interest in the particular job post, such as follow up messages. The tracking engine 116 may also track the number of job seeker profile views, resume downloads, and other actions performed by job posters that may show a level of satisfaction on the part of the job poster.

In an embodiment, the tracking engine 116 may track job seeker interactions with respect to the particular job, including but not limited to, whether a job seeker clicks on the particular job posting presented, the number of impressions within job seeker feeds and job search results for the particular job, the number of job seekers that applied for the particular job, the number of job seekers that participated in associated screening questions, the number of job seekers that passed the screen questions, and any other interactions by job seekers that indicate interest in the particular job post.

In an embodiment, the tracking engine 116 may track user interactions for a specific duration of time. For example, in order to understand how well a job posting is performing, interactions with the job posting are tracked for a specific duration of time, such as a period of two days. Often users of the content management system 110 may log into the system 110 at specific times during the day. For instance, a subset of job seekers may tend to log into the content management system 110 in the morning, while another subset of job seekers may tend to log into the content management system 110 in the evening. Similar user session trends may apply to job posters and when job posters review candidates for their job postings. As a result, the tracking engine 116 may set a specific duration of time to collect user interaction data, such as 2 days, 3 days, or one week. In other instances, the duration of time may be longer or shorter based upon the type of job opportunity, such as if the job opportunity is expected to be very popular with job seekers, then the duration of time may be shorter. Conversely, if the job opportunity requires a high level of experience or qualifications, then the duration of time may be longer in order to account for various times during the day or the week that relevant job seekers may interact with the job post.

In an embodiment, the tracking engine 116 may store user interactions within the interaction database 144. The interaction database 144 may store user interactions associated with different job postings as well as historical user interaction data associated with historical job postings. For example, historical user interactions for a set of job postings for database engineers over the past year may be stored within the interaction database 144. User interactions for the particular job posting and user interactions for historical job postings may be used by the job post evaluation service 118 to determine how well the particular job posting is performing relative to similar job postings that have been previously posted.

In an embodiment, the tracking engine 116 actively tracks and stores user interactions for all active job postings in the interaction database 144. For example, if a job posting has been active for a month, the tracking engine 116 tracks and stores all user interactions related to the job posting for the entire month that the job posting has been active. If the job poster edits attributes of the job post, such as changing the job title or modifying the screen questions, the tracking engine 116 may account for the changes and associate subsequent user interactions to the updated version of the job posting. Tracking and associating user interactions to the corresponding version of the job posting is useful for evaluating whether changes made to the job posting have increased or decreased relative performance of the job posting with respect to corresponding user interactions.

### Job Post Evaluation Service

In an embodiment, the job post evaluation service 118 determines how well a job posting is performing using related user interaction metrics captured by the tracking engine 116. Evaluating performance of a particular job posting may be based on levels of interactions by job seekers, job posters, as well as by the number of qualified job seekers that applied for the job opportunity. Performance of the particular job may be relative to other job postings with similar job attributes. The job post evaluation service 118 may compare user interaction metrics from the particular job posting to historical or current user interaction metrics associated with other job postings that have been identified as being similar to the particular job post. For example, if a job poster generates a new job posting for a database engineer job, then performance metrics of the new database engineer job posting may be evaluated against performance metrics of similar database engineer job postings. If the performance metrics for the new database engineer job posting are below a performance threshold, which is based on the historical (or current) performance metrics for the similar database engineer job postings, then the new database engineer job posting is performing poorly relative to similar job postings. If, however, the performance metrics for the new database engineer job posting are near the same level or above the historical (or current) performance metrics for the similar database engineer job postings, then the new job posting is performing well relative to the similar database engineer job postings.

### Similar Job Postings

In an embodiment, the job post evaluation service 118 determines other job postings that are similar to a particular job posting by identifying the other job postings that have similar job attributes. For example, the particular job posting has associated job attributes, such as job title, job location, job seniority, job skills, educational requirements or preferences, a job description, and a set of screening questions. The job post evaluation service 118 may identify a subset of the job attributes from the particular job posting and compare the subset of job attributes to job attributes of other job postings in order to identify similar job postings. For instance, if the particular job posting is the database engineer job post, which has a job title of “database engineer”, is located in Mountain View Calif., and has job seniority set to mid-level, then the job post evaluation service 118 may search the previously posted job postings to identify a set of similar job postings that have the same or similar job titles to database engineer, have job locations matching or near Mountain View Calif., and have job seniority level equal to or similar to mid-level.

In an embodiment, the criteria for determining the set of similar job postings may be based on either matching one or more job attribute values to the particular job posting or by determining that one or more job attribute values for similar job postings are similar to the job attribute values of the particular job post. For instance, if the particular job posting has a job title of “database technician”, then the job post evaluation service 118 may determine that 10 other job postings are similar based on the 10 other job postings having job titles of “database engineer.” In an embodiment, the job post evaluation service 118 may implement a threshold of similarity for determining whether a job posting is similar to the particular job post. The threshold of similarity may take into account one or more job attributes and various levels of similarity between job attribute values. For example, if the job post evaluation service 118 determines a high number of job postings that have similar job attributes to the particular job post, then the job post evaluation service 118 may raise the threshold of similarity in order to filter out a subset of other job postings that are only marginally similar while keeping another subset of other job postings that have job attribute values that closely match the job attribute values of the particular job post. In another example, the job post evaluation service 118 may lower the threshold of similarity in order to identify additional job postings that may be similar to the particular job post. This may occur if the particular job posting attribute values do not closely match other job posting attribute values, thus leading to very few or no other job postings that were initially found to be similar.

### Performance Benchmarks and Thresholds

In an embodiment, the job post evaluation service 118 may determine one or more performance benchmarks for a particular job posting using user interaction metrics associated with the set of similar job postings. For example, performance benchmarks may be based on job seeker interactions that include, but are not limited to, click through rates, a number of job application submissions, a percentage of job applicants that complete the screening questions, a percentage of job applicants that pass the screening questions, a percentage of job applicants that fail the screening questions, and any other user interaction metric associated with job seekers. Performance benchmarks may also be based on job poster interactions that include a number of job application reviews by job posters, a number of job seeker user profiles and resumes viewed by job posters, and any other user interaction metric associated with job posters. In an embodiment, the performance benchmarks may be calculated as an average of the user interaction metrics for each similar job post. For instance, the performance benchmark for click through rate may be the average click through rate value of each job posting in the set of similar job postings. In another embodiment, the performance benchmarks may be calculated as a median value of the user interaction metrics for each similar job post.

The one or more performance thresholds may be based on the performance benchmarks calculated from the user interaction data associated with the set of similar job postings. In one example, a performance threshold may be set as a percentage value of a performance benchmark. For example, the performance threshold for received job applications may be set to be 80% of the performance benchmark for received job applications. That is, if the performance benchmark for received job applications is 1000 applications per week (calculated as the average of the received job applications for the set of similar job postings), then the performance threshold may be set at 800 applications per week. In another example, the performance threshold may be set as a number of standard deviations from the mean performance benchmark. For instance, if the first standard deviation for an average of 1000 applications per week is 150 and the performance threshold is set at one standard deviation from the mean, then the performance threshold would be set to 850 applications per week. In yet other examples, the performance threshold may be based on percentages of the benchmark values, standard deviations from the benchmark value, or any other calculated value based on the performance benchmark.

In another embodiment, if the job post evaluation service 118 determines that there are no similar job postings to the particular job posting based on the job attributes of the particular job post, then the job post evaluation service 118 may implement a number of default performance threshold values. The default performance threshold values may be based on performance benchmarks calculated from the entire set of job postings in the job post database 142 or a subset of job postings in the job post database 142, where the subset is based on an industry, subindustry, region, subject matter, or any other category.

### Job Post Suggestion Service

In an embodiment, if the job post evaluation service 118 determines that the user interaction metrics of the particular job posting are below the one or more performance thresholds, then the job post evaluation service 118 may send a request to the job post suggestion service 120 to provide one or more suggestions to edit the job post. For example, if the particular job posting for “database engineer” performs poorly, based on click through rate, with respect to the set of similar job postings, then the job post evaluation service 118 may send a request, which includes job attributes of the particular job posting and the job attributes of the job postings in the set of similar job postings, to the job post suggestion service 120.

In an embodiment, the job post suggestion service 120 determines one or more suggestions to modify a job posting in order to improve performance metrics for the job post. For example, the job post suggestion service 120 may analyze the job attributes of a particular job with respect to job attributes of similar jobs to determine one or more suggested changes to make to the particular job post. The one or more suggested changes may be based on differences in job attribute values between the particular job and the similar jobs. For instance, if the particular job has a job title as “Database Rockstar” and the identified similar jobs have different job titles, such as “senior database engineer”, “database architect”, and “lead database engineer”, then the job post suggestion service 120 may suggest a change to the job title.

### Suggested Changes to a Job Posting

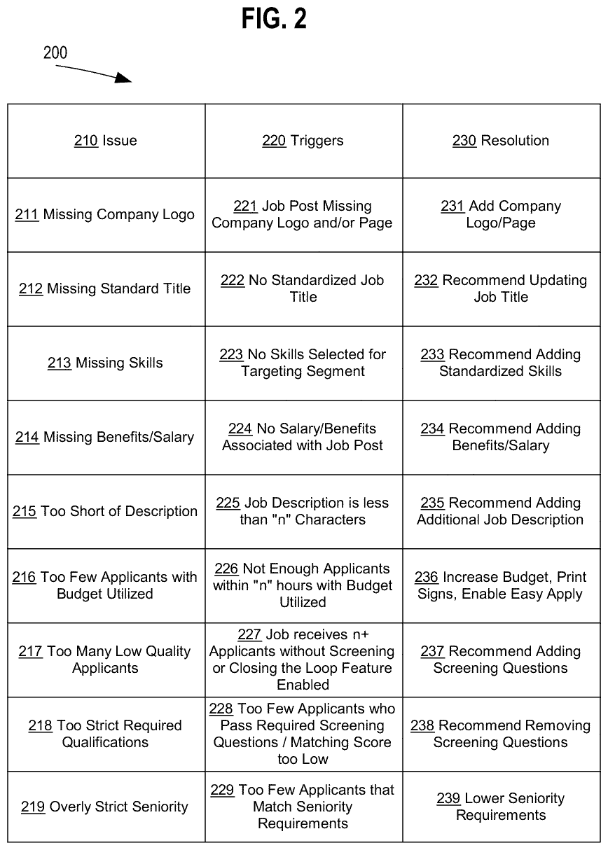

In an embodiment, the suggestion database 146 may contain stored suggestions of changes that may be made to a job posting in order to increase performance. FIG. 2 depicts a table of sample suggested changes to be made to a job posting for the purpose of increasing relative performance of the job post. Table 200 represents a table of suggestions organized by issues and by performance triggers. Suggestions in table 200 may be stored in the suggestion database 146 and accessed by the job post suggestion service 120. Issue column 210 represents general issues that may be causing poor performance. For example, a job attribute is missing or the job attribute value is not a standardize value, too many or too few job applications received, or too strict or not strict enough screening questions. Triggers column 220 represents identified job attribute values and/or user interaction metrics that cause a specific issue. Resolution column 230 represents specific suggestions a job poster may make to a job posting in order to increase performance of the job post.

Referring to the suggested changes in table 200, issue 211 “Missing company logo” is an issue that indicates that the particular job posting is missing a company logo and/or company link to a webpage. Trigger 221 “Job post missing company logo and/or page” represents a specific trigger identifying that the particular job posting is missing the company logo and/or a link to the company webpage of the company providing the job opportunity. Resolution 231 “Add company logo and/or webpage” represents a suggestion to be presented to the job poster that informs the job poster to add a company logo and/or link to the company webpage in order to increase performance of the particular job post.

Issue 212 “Missing standardized title” is an issue that indicates that the particular job posting is missing a standard job title. This may occur if the job poster used a non-standard job title, such as “Rockstar” or “Database Rockstar”. Standardized titles refer to job titles typically used by companies to describe a job. Standardized job titles may have been identified from multiple existing job postings. For example, if the job title “Database Rockstar” has been used in several different job postings and has been identified as being used by different companies to describe jobs, then the job post suggestion service 120 may insert the job title into suggestion database 146 as a standardized job title. Trigger 222 “No standardized job title” represents a specific trigger identifying that the job title attribute value for the particular job contains a non-standard job title. The suggestion database 146 may store a list of standardized job titles. Resolution 232 “Recommend updating job title” represents a suggestion to be presented to the job poster that informs the job poster to update the job title to a standardized job title.

Issue 213 “Missing skills” is an issue that indicates that the particular job posting is missing job skills. This may occur if the job poster omitted entering job skills for the particular job post. This issue may also occur if there are too few job skills associated with the particular job post. Trigger 223 “No skills selected from targeting segment” represents a specific trigger identifying that the job skills attribute value for the particular job is null or contains very few skills when compared to similar job postings. Resolution 233 “Recommend adding standardized skills” represents a suggestion to be presented to the job poster that informs the job poster to add additional job skills to the job post.

Issue 214 “Missing benefits and/or salary” is an issue that indicates that the particular job posting is missing benefits and/or a salary for the specific job opportunity. Trigger 224 “No salary or benefits associated with job post” represents a specific trigger identifying that the benefits attribute value and/or the salary attribute value for the particular job is null. Resolution 234 “Recommend adding benefits/salary” represents a suggestion to be presented to the job poster that informs the job poster to add benefit information and/or salary information to the job post.

Issue 215 “Too short of a description” is an issue that indicates that the description job attribute of the particular job posting is not long enough. This may cause job seekers not to apply to the job posting because the description of job opportunity is not descriptive enough to be considered. Trigger 225 “Job description is less than ‘n’ characters” represents a specific trigger indicating that the job description is too short based on the number of characters and relative to the identified similar jobs. Resolution 235 “Recommend adding additional job description” represents a suggestion to be presented to the job poster that informs the job poster to add additional job description details to the job post.

Issue 216 “Too few applicants with budget utilized” is an issue that indicates that the particular job posting has received too few applicants and the job poster's budget for activating the particular job posting has been exhausted. In an embodiment, activation of a job posting is based on a budget provided by the job poster. The size of the budget influences the frequency of impressions of the job posting in the content management system 110. For example, if the budget is set to $1000 then the job posting may be presented 10 times more frequently than if the budget is set to $100 for the job post. Trigger 226 “Not enough applicants within ‘n’ hours with the budget utilized” represents a specific trigger identifying that too few applicants have applied or viewed the job posting within a period of time (‘n’ hours) and the budget allocated for the job posting has been utilized. Resolution 236 “Increase budget, print signs, and enable easy apply” represents suggestions to be presented to the job poster that informs the job poster on how to increase job posting performance by either increasing the daily budget allotted to the particular job post, printing physical signs that may be displayed by the employer, and/or enabling easy apply within the job post. Increasing the daily budget may increase the number of applicants by exposing the job posting to more job seekers based on the increased budget. Printing physical signs is a suggestion to advertise outside of the content management system 110. This may be useful for job opportunities where job seekers may find the job opportunity by walking past a storefront. Enabling easy apply refers to a job posting feature within the content management system 110 which allows job seekers to apply to a job opportunity by clicking the “easy apply” button within the job post.

Issue 217 “Too many low quality applicants” is an issue that indicates that the job posting is receiving many job applications but the job seekers that are applying lack the desired job skills. Trigger 227 “Job receives ‘n+’ applicants without screening or closing loop feature enabled” represents a specific trigger indicating that the job has received many applicants but a majority of the applicants are not qualified for the job. This may occur if the number of job applications are high but the number of pursued job seekers is very low. For example, the user interactions metrics indicate a high number of job seekers applying for the job opportunity but the user interaction metrics also indicate that the job poster is accepting and/or following up with very few job seekers/applicants. This may occur if the job poster did not enable screen questions or that the screening questions are not rigorous enough to adequately filter out unqualified job seekers. <Inventors, please indicate what closing the loop feature means.> Resolution 237 “Recommend adding screening questions” represents a suggestion to be presented to the job poster that informs the job poster to add screening questions in order to automatically filter out unqualified job seekers.

Issue 218 “Too strict required qualifications” is an issue that indicates that the screening questions are too rigorous resulting in too few applicants that pass the job screen questions. Trigger 228 “Too few applicants who pass required screening questions/matching score is too low” represents a specific trigger indicating that the percentage of job applicants who pass the screening questions is too low relative to similar job postings. The screening question section of the job posting may be based on a pass/fail outcome where a job seeker either passes or fails based on the number of correctly answered screening questions. In another example, the screening question section may produce a matching score that is then forwarded to the job poster for review. If the screening questions are too strict, then the number of passing applicants or the number of low match scores will be high. This may occur if too many of the screening questions are set to “required” instead of “preferred”. Resolution 237 “Recommend removing screening questions” represents a suggestion to be presented to the job poster that informs the job poster to remove screening questions from the screen in order to allow more job applicants to pass the screening section. Another recommendation may be to change options for screening questions from “required” to “preferred”. This may result in more job applicants passing the screening question as fewer questions need to be correct. For example, if one of the screening questions is “are you able to work in the United States?”, by changing this screening question from required to preferred, job applicants from other countries who may not be currently approved to work in the United States may pass the screening section.

Issue 219 “Overly strict seniority” is an issue that indicates that the seniority job attribute of the particular job posting is requires too much experience. Trigger 229 “Too few applicants that match seniority requirements” represents a specific trigger indicating that too few job seekers have applied for the job post. Additionally, if the similar job postings have lower seniority requirements, the job post suggestion service 120 may identify the particular job posting for this issue based on the disparity in job seniority between the particular job posting and the similar job postings and the low number of job applications. Resolution 239 “Lower seniority requirements” represents a suggestion to be presented to the job poster that informs the job poster to lower the seniority requirements in order to increase the potential pool of job seekers.

### Suggestion Tiers

In an embodiment, different suggestions may be grouped into different suggestion tiers based upon the suggestion type and trigger type. For instance, suggestions to add values for missing job attributes may be grouped into one suggestion tier, while suggestions to modify attribute values, such as screening questions, budget allotments, and job seniority levels, may be grouped into another suggestion tier.

In an embodiment, a first suggestion tier may be generated that includes suggestions that are based on differences between job attributes of the particular job and the identified similar jobs. The differences in job attributes may also include missing job attribute values, such as a missing company logo or webpage. Referring to table 200, the first suggestion tier may include: issue 211 (missing company logo), issue 212 (missing standard title), issue 213 (missing skills), issue 214 (missing benefits/salary), and issue 215 (too short of description). Each of these issues have triggers that are based upon either missing job attribute values or job attribute values that differ from job attribute values of similar jobs. For example, triggers 221, 223, and 224 (corresponding to issues 211, 213, and 214) each correspond to missing attribute values, such as missing company logo, missing job skills, and missing salary or benefits. In another example, triggers 222 and 225 (corresponding to issues 212 and 215) each correspond to attribute values that differ from job attribute values of similar jobs. Trigger 222 corresponds to when the job title attribute for the particular job differs from the standardized job titles represented by the similar jobs. For instance, the job title for a database engineer job is “Rockstar” while the job titles from the similar jobs include “database engineer”, “database architect”, and “database technician.” Trigger 225 corresponds to when the job description is less than a threshold number of characters. The threshold number of characters may be based on an average length of job descriptions for similar jobs.

In an embodiment, a second suggestion tier may be generated that includes suggestions that are based on specific performance metrics, such as the number of job applications received, the number of job applicants that pass the screening questions, or any other performance metric based on job applications. Referring to table 200, the second suggestion tier may include: issue 216 (too few applicants with budget utilized), issue 217 (too many low quality applicants), issue 218 (too strict required qualifications), and issue 219 (overly strict seniority). Each of the above issues is related to performance metrics associated with secondary user interactions, such as submitting a job application, answering the screening questions, and reviewing job applications by the job poster.

In an embodiment, different suggestion tiers may be associated with different durations of time for tracking user interaction data. For example, suggestions in the first tier may be associated with a shorter duration for tracking user interactions. The tracking engine 116 may track one day's worth of user interaction data and then send a request to the job post evaluation service 118 to determine whether the particular job posting is performing well or poorly. If the particular job posting is missing job attributes, such as job salary, then the job posting evaluation service 118 may, after one day, determine that the particular job is performing poorly based on click though rate. The job post evaluation service 120 may then identify the missing job attribute values for salary and suggest to the job poster to add a job salary value.

In another example, suggestions in the second tier may be associated with a longer duration for tracking user interactions. Suggestions in the second tier are generally based on user interactions related to follow ups and submitting job applications. For this reason, a longer duration time may be advisable as job seekers may not immediately submit their job application or answer the screening questions associated with the particular job post.

### Ranking Suggestions

The job post suggestion service 120 may determine a set of potential suggestions to modify a job posting based on the job attributes of the particular job with respect to job attributes of similar jobs. In an embodiment, the job post suggestion service 120 may rank the suggestions in the set of potential suggestions by implementing a machine-learned model that scores and ranks potential suggestions using historical performance metrics of previously active job postings. The machine-learned model may receive, as input, the job attributes of the particular job post, job attributes from similar job postings, and the set of potential suggestions. The output of the machine-learned model may be a ranking of the suggestions in the set of potential suggestions based upon a score assigned to each suggestion. The machine-learned model may be trained using historical performance metrics captured before a suggestion is applied, job attributes from the particular job posting and similar job postings, and labeled performance metrics captured after the suggestion has been applied. The labels may indicate whether the suggestion improved performance or not. <Inventors, please provide some example ML model techniques that you would like me to list.>

In another embodiment, the job post suggestion service 120 may implement a rule-based model that ranks suggestions based upon the differences of job attribute values between the particular job posting and similar job postings. For example, if the particular job posting is missing a company logo, standard job title, job skills, benefits/salary, and has too short of a description, then the rule-based model may rank the suggestions in order of importance where issue 212 (missing standard title) is ranked highest, then issue 213 (missing skills), then issue 214 (missing benefits/salary), and issue 215 (too short of description), and then issue 211 (missing company logo). The ranking rules may be based on historical performance metrics observed before and after suggestions were applied.

### Suggestion Content

In an embodiment, the job post suggestion service 120 may select a suggestion for presentation, generate a suggestion message, and send the suggestion message to poster device 122. The suggestion message may represent an object that contains the selected resolution and specific content that may be derived from the similar job postings. For example, if the job post suggestion service 120 selects issue 122 (missing standard title) as the suggestion, then the suggestion message may contain resolution 232 (recommend updating job title) and one or more standardized job titles as specific content. The one or more standardized job titles may be derived from the set of similar job postings. For instance, if the job opportunity is a database engineer job and the particular job posting contains the job title attribute as “Database Rockstar”, then the job post suggestion service 120 may identify standardized job titles of “database engineer” and “database lead” from the set of similar job postings and insert the standardized job titles into the suggestion message.

In an embodiment, the job post suggestion service 120 may implement a machine-learned model to derive suggestion content from job attribute values from the particular job posting and the set of similar job postings. For example, if the selected suggestion is resolution 237 (recommend adding screen questions), then the machine-learned model may receive as input the job description attribute and analyze the text within the job description to identify potential additional screening question. Additionally, the machine-learned model may receive as input the current screening questions of the particular job posting and the screen questions associated with the set of similar job postings. <Inventors, please specify any conventional ML techniques that should be mentioned for this use case.>

### Processing Overview

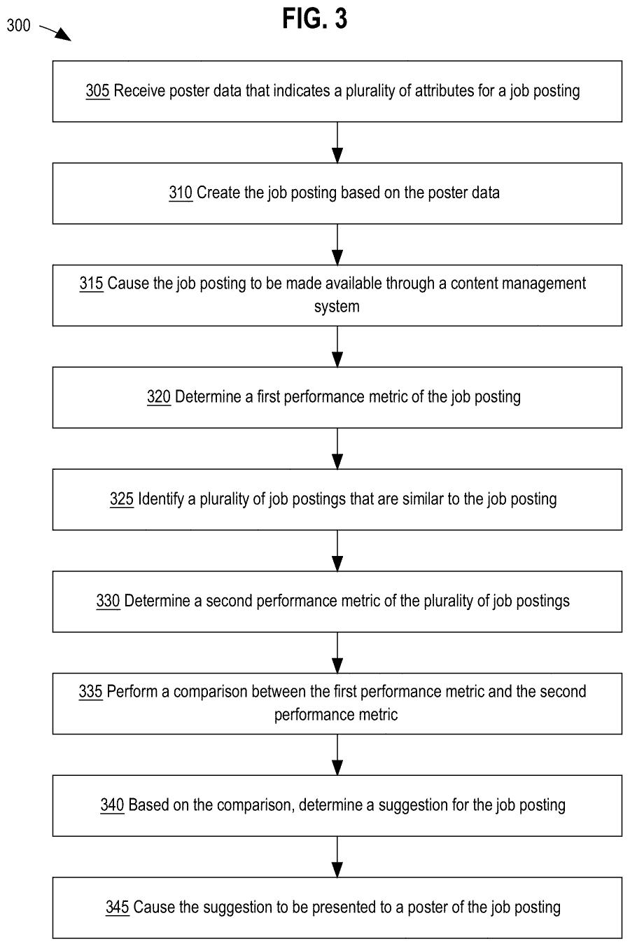

FIG. 3 depicts an example flowchart for selecting a suggested change to data in a job posting and presenting the suggested change to a job poster device. Process 300 may be performed by a single program or multiple programs. The operations of the process as shown in FIG. 3 may be implemented using processor-executable instructions that are stored in computer memory. For purposes of providing a clear example, the operations of FIG. 3 are described as performed by components described in system 100. For the purposes of clarity process 300 is described in terms of a single entity. In an embodiment, the job poster portal 112, the tracking engine 116, the job post evaluation service 118, the job post suggestion service 120, and the content management system 110 may perform operations of process 300.

In operation 305, process 300 receives poster data that indicates a plurality of attributes for a job posting. In an embodiment, the job poster portal 112 may receive a request to generate a job post. The request may include the poster data that specifies job attributes for the job posting to be created. For example, the poster data may include, but is not limited to, the job title, job description, job skills, job seniority, job location, job benefits and salary, as well as any screening questions to be included. In one example, the job poster data may include a job title and a detailed description that may be parsed by the job poster portal 112 in order to identify relevant job attributes. For instance, job seniority, job skills, job location, job benefits and salary may be parsed from the job description.

In operation 310, process 300 creates the job posting based on the poster data. In an embodiment, the job poster portal 112 may create a data object representing the job posting and store the data object within the job post database 142. The data object may contain the job attributes identified from the poster data. In an embodiment, the job poster portal 112 may implement one or more quality control checks that verify that the provided poster data contains the necessary information to generate a valid job post. For example, the quality control checks may verify that at least a job title and a job description has been provided. The job poster portal 112 may implement a minimum amount to data verification in order to reduce the amount of friction for the job poster when creating a new job post. In other examples, the job poster portal 112 may implement more or less quality control checks to validate a newly created job posting.

In operation 315, process 300 causes the job posting to be made available through a content management system. In an embodiment, upon creating and storing the job posting, the content management system 110 may activate the job posting so that the job posting is available for viewing by job seekers. For example, the content management system 110 may present the job posting as content within a content feed or as part of search results of a search performed by job seekers using the job seeker portal 114.

Operations 320-340 may be performed while the job posting is active in the content management system 110. In operation 320, process 300 determines a first performance metric of the job posting. In an embodiment, the tracking engine 116 may track user interactions related to the job posting. For example, user interactions by job seekers may include, but are not limited to, clicking on the job posting, applying for the job posting, viewing the job posting in a content feed or in search results, answering screening questions associated with the job posting, and replying to any follow up messages related to the job posting. Additionally, user interactions by job posters may be tracked, which include, but are not limited to, reviewing job applicants, job applicant profiles, resumes, screen answers, and following up with job applicants. The user interactions may be stored in the interaction database 144.

In an embodiment, the tracking engine 116 may track user interactions for a specified period of time. For example, user interactions for the job posting may be tracked for a period of 5 days. In other embodiments, the period of time for tracking user interactions may be longer or shorter based upon the type of job posting. For example, if the job posting includes extensive job requirements and skills, such as a PhD in Electrical Engineering, then the tracking engine 116 may extend the period of time to ensure that the sample size of user interactions is large enough.

In another embodiment, the tracking engine 116 may implement multiple time windows for tracking user interactions. For example, a first time window for a period of 2 days may be used to track initial user interactions, such as click through rate and job posting views. The initial user interactions may be sent to the job post evaluation service 118 and subsequently the job post suggestion service 120 in order to identify whether a suggestion from the first tier of suggestions should be presented to the job poster. The first tier of suggestions may include simple changes, such as adding a missing company logo, missing job skills, missing salary and benefits. A second time window for a period of one week may be used to track more involved user interactions, such as answering screening questions, job poster application reviews, and follow up messages. The more involved user interactions may be sent to the job post evaluation service 118 and subsequently the job post suggestion service 120 in order to identify whether a suggestion from the second tier of suggestions should be presented to the job poster. The second tier of suggestions may include suggestions to modify screening questions and either make qualifications and/or screen questions either more or less strict. The second tier of suggestions may be suggestions related to modifying the quality and quantity of job applications received, which may be based on a longer time window for tracking user interactions.

Referring to FIG. 3, in operation 325, process 300 identifies a plurality of job postings that are similar to the job posting. In an embodiment, the job post evaluation service 118 may determine similar job postings to the job posting for the purpose of determining the job posting is performing well by comparing the job posting user interactions to user interactions of similar job postings. The job post evaluation service 118 may compare job attribute values between the job posting and other existing job postings to determine a plurality of job postings that are similar. For example, the job post evaluation service 118 may identify similarities between job attribute values including, but not limited to, the job title attribute, the skills attribute, the job location attribute, the job seniority attribute, and keywords from the job description attribute. Upon determining similarities between job attribute values, the job post evaluation service 118 identifies the plurality of job postings that are similar to the job posting.

In operation 330, process 300 determines a second performance metric of the plurality of job postings. In order for the job post evaluation service 118 to compare performance metrics between the job posting and the plurality of job postings, the job post evaluation service 118 requests from the tracking engine 116 user interaction data for the plurality of job postings. The tracking engine 116 may query the interaction database 144 and retrieve user interaction data for the plurality of job postings. In an embodiment, the job post evaluation service 118 may aggregate the user interaction data for the plurality of job postings and generate performance benchmarks that may be average values of performance metrics from each of the job postings in the plurality of job postings. For example, the benchmark click through rate may be an average of the click through rates from each of the job postings in the plurality of job postings. In other embodiments, the job post evaluation service 118 may implement other mathematical operations to generate the performance benchmarks for the plurality of job postings. The job post evaluation service 118 may then select a performance benchmark to represent the second performance metric to compare against the first performance metric of the job posting.

In operation 335, process 300 performs a comparison between the first performance metric and the second performance metric. The job post evaluation service 118 compares the first performance metric and the second performance metric to determine whether the job posting is performing adequately or is performing poorly, compared to the plurality of job postings that are similar. In an embodiment, the job post evaluation service 118 may determine a performance threshold that defines whether the job posting is performing poorly or not. For example, if the first performance metric is below the performance threshold, then the job posting is performing poorly. If however, the first performance metric is at or above the performance threshold, then the job posting is performing adequately. In an embodiment, the performance benchmark may be based on the second performance metric. For example, the performance benchmark may be a percentage of the second performance metric, such as 80% of the second performance metric. In other examples, the performance benchmark may be based on any configurable percentage value, standard deviation value, or absolute value of the second performance metric.

In operation 340, based on the comparison performed in operation 335, process 300, determines a suggestion for the job posting. The job post evaluation service 118 send a request, which includes the job posting and the plurality of job postings, to the job post suggestion service 120 to determine a suggestion for editing the job posting. In an embodiment, the job post evaluation service 120 may determine one or more suggestions to improve performance metrics for the job posting by comparing job attributes values of the job posting to job attribute values of the plurality of job postings in order to identify differences in job attribute values. For example, if the job post evaluation service 120 determines that the job skills attribute of the job posting does not contain JAVA and PERL while the plurality of job postings each contain JAVA and PERL, then the job post evaluation service 120 may identify issue 213 (missing skills) as the potential issue and may select resolution 233 (recommend adding standardized skills) as the suggestion for the job posting.

In an embodiment, the job post evaluation service 120 may identify several job attributes that may need editing, and as a result identify a set of potential suggestions. The job post evaluation service 120 then rank the suggestions in the set of potential suggestions. In one example, the job post evaluation service 120 may implement a machine-learned model for ranking the suggestions. The rankings may be based on the attributes of the job posting, attributes of the plurality of job postings, and historical user interaction data associated with the plurality of job postings. In another example, the job post evaluation service 120 may implement a rule-based model that ranks suggestions based upon the differences of job attribute values between the particular job post and similar job postings. Upon ranking the set of potential suggestions, the job post evaluation service 120 may select the highest ranked suggestion of the set of potential suggestions, as the suggestion for the job posting.

In operation 345, process 300 causes the suggestion to be presented to the poster of the job posting. In an embodiment, upon determining the suggestion to use, the job post evaluation service 120 generates a suggestion message that includes the suggestion to use and specific content from the plurality of job postings as examples of the suggestion. For example, if the suggestion is resolution 232 (recommend updating job title), then the job post evaluation service 120 may identify one or more standardized job titles from the plurality of job postings and include the one or more standardized job titles as examples to update the job title for the job posting. Upon generating the suggestion message, the content management system 110 may send the suggestion message to the posting device 122, which is used by the job poster. In one example, the suggestion message may be sent to the job poster portal 112, which may display a popup message on the client application on the poster device 122.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

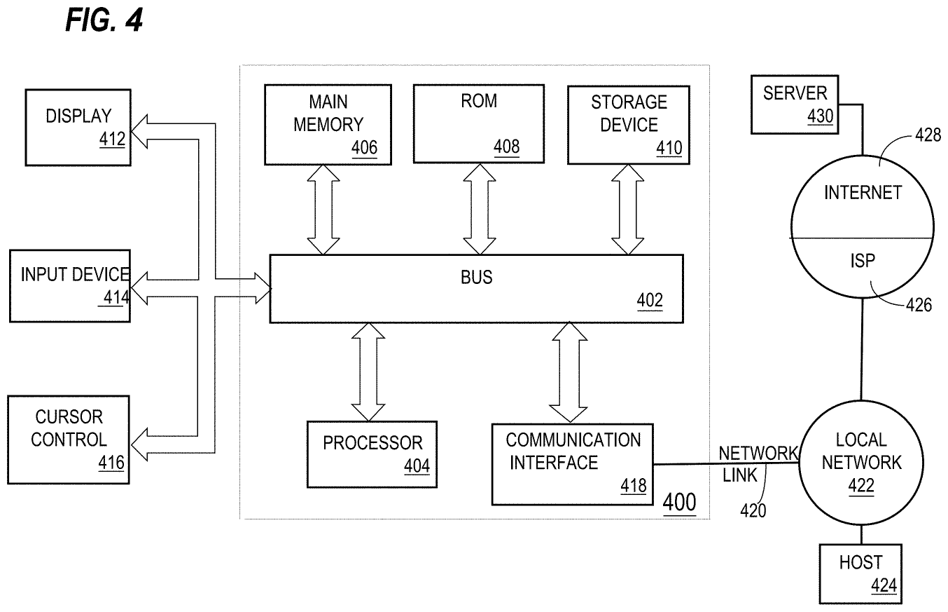

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving job post information that indicates a plurality of attributes for a job opportunity;
creating a job post based on the job post information for the job opportunity;
causing the job post to be made available through a content management system;
while the job post is available:
determining a first performance metric of the job post;
identifying a plurality of job posts that are similar to the job post;
determining a second performance metric of the plurality of job posts;
performing a comparison between the first performance metric and the second performance metric;
based on the comparison, determining a suggestion for the job post;
causing the suggestion to be presented to a poster of the job post;
wherein the method is performed by one or more computing devices.

2. The method of claim 1, wherein determining the suggestion for the job post comprises:
based on the comparison, identifying a set of suggestions;
ranking suggestions in the set of suggestions based upon historical user interaction data associated with the plurality of job posts; and
selecting the suggestion from the set of suggestions based upon the ranking of the suggestions in the set suggestions.

3. The method of claim 2, wherein ranking the suggestions in the set of suggestions comprises, ranking the suggestions in the set of suggestions based upon the historical user interaction data associated with the plurality of job posts, the plurality of attributes for the job post, and attributes associated with the plurality of job posts.

4. The method of claim 1, wherein the suggestion comprises content identifying one or more missing attributes from the job post, the one or more missing attributes include at least one of a company logo, a company webpage link, a standardized job title, a job skill, job benefits, job salary, or job description.

5. The method of claim 1, wherein the suggestion comprises content that specifies suggested attributes values including one or more standardized job title values or one or more job skill values.

6. The method of claim 1, wherein the suggestion comprises one or more screening questions to remove from the plurality of attributes for the job post.

7. The method of claim 1, wherein the suggestion comprises one or more screening questions to add to the plurality of attributes for the job post.

8. The method of claim 1, wherein determining the first performance metric of the job post comprises:
collecting user interaction data related to the job post for a period of time; and
determining the first performance metric from the user interaction data.

9. The method of claim 8, wherein the period of time is based on an estimated number of candidate job seekers.

10. The method of claim 1, wherein the plurality of job posts are identified based on similarities between one or more attributes of the job post and the plurality of job posts, wherein the one or more attributes include at least one of a job title attribute, one or more skills attributes, a job location attribute, a job seniority attribute, or keywords from a job description attribute.

11. A computer program product comprising:
one or more non-transitory computer-readable storage media comprising instructions which, when executed by one or more processors, cause:
receiving job post information that indicates a plurality of attributes for a job opportunity;
creating a job post based on the job post information for the job opportunity;
causing the job post to be made available through a content management system;
while the job post is available:
determining a first performance metric of the job post;
identifying a plurality of job posts that are similar to the job post;
determining a second performance metric of the plurality of job posts;
performing a comparison between the first performance metric and the second performance metric;
based on the comparison, determining a suggestion for the job post; and
causing the suggestion to be presented to a poster of the job post.

12. The computer program product of claim 11, wherein determining the suggestion for the job post comprises:
based on the comparison, identifying a set of suggestions;
ranking suggestions in the set of suggestions based upon historical user interaction data associated with the plurality of job posts; and
selecting the suggestion from the set of suggestions based upon the ranking of the suggestions in the set suggestions.

13. The computer program product of claim 12, wherein ranking the suggestions in the set of suggestions comprises, ranking the suggestions in the set of suggestions based upon the historical user interaction data associated with the plurality of job posts, the plurality of attributes for the job post, and attributes associated with the plurality of job posts.

14. The computer program product of claim 11, wherein the suggestion comprises content identifying one or more missing attributes from the job post, the one or more missing attributes include at least one of a company logo, a company webpage link, a standardized job title, a job skill, job benefits, job salary, or job description.

15. The computer program product of claim 11, wherein the suggestion comprises content that specifies suggested attributes values including one or more standardized job title values or one or more job skill values.

16. The computer program product of claim 11, wherein the suggestion comprises one or more screening questions to remove from the plurality of attributes for the job post.

17. The computer program product of claim 11, wherein the suggestion comprises one or more screening questions to add to the plurality of attributes for the job post.

18. The computer program product of claim 11, wherein determining the first performance metric of the job post comprises:
collecting user interaction data related to the job post for a period of time; and
determining the first performance metric from the user interaction data.

19. The computer program product of claim 18, wherein the period of time is based on an estimated number of candidate job seekers.

20. The computer program product of claim 11, wherein the plurality of job posts are identified based on similarities between one or more attributes of the job post and the plurality of job posts, wherein the one or more attributes include at least one of a job title attribute, one or more skills attributes, a job location attribute, a job seniority attribute, or keywords from a job description attribute.
